(19) United States
(12) Patent Application Publication
(10) Pub. No.: US 2013/0255802 A1
(43) Pub. Date: Oct. 3, 2013

(54) VALVE AND HYDRAULIC CONTROLLER

(71) Applicant: Kevin Peter Minnock, Co Longford (IE)

(72) Inventor: Kevin Peter Minnock, Co Longford (IE)

(73) Assignee: CAMERON INTERNATIONAL CORPORATION, Houston, TX (US)

(21) Appl. No.: 13/437,845

(22) Filed: Apr. 2, 2012

(51) Int. Cl. F16K 37/00; F16K 31/12; F16K 11/22

(52) U.S. Cl. 137/554; 137/606; 251/30.01; 251/62

(57) ABSTRACT

A valve and a hydraulic controller are provider. The valve may combine a rotary-to-linear converter with the hydraulic controller to provide for at least two mechanisms for actuating the valve. Additionally, the valve may include a mechanical lock mechanism suitable for securing the valve at a desired flow position. The mechanical lock mechanism may also provide overload protection. That is, the mechanical lock mechanism may “slip” or disengage if torque forces reach undesired levels. The hydraulic controller may enable a “stepping” mode of control and “fast actuation” mode of control. The “stepping” mode may deliver a discrete quantity of a fluid, while the “fast actuation” mode may deliver a continuous quantity of the fluid.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A valve, such as a choke valve, is capable of controlling a flow through a conduit. The valve may be opened, for example, by actuating a piston that enables a flow of fluid through the valve. The flow may thus move from a first end or entry port of the valve, traverse the valve, and continue through a second end or exit port of the valve. Likewise, the valve may be closed by actuating the piston so as to obstruct or occlude the flow of fluid. Unfortunately, some valves experience high fluid pressures, and the high fluid pressures may cause inadvertent opening of the valve or leaking.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a block diagram of embodiments of a valve and a valve controller;

FIG. 2 is a block diagram of embodiments of the valve of FIG. 1 and a valve controller;

FIG. 3 is cross-sectional side view of an embodiment of the valve of FIG. 1;

FIG. 4 is a block diagram of embodiments of a valve and a valve controller;

FIG. 5 is an exploded cross-sectional side view of embodiments of a flow control insert and a flow control insert housing of the valve of FIG. 4; and

FIG. 6 is a cross-sectional side view of embodiments of the flow control insert and the flow control housing of FIG. 5.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

The disclosed embodiments include a valve, such as a choke valve, including a mechanical valve locking mechanism suitable for securely locking a valve piston at one or more positions. That is, the valve piston may be locked in a range of positions varying from an approximately fully closed position to an approximately fully open position. Additionally, the valve may include a rotary-to-linear converter that enables the conversion of rotary motion into linear motion suitable for moving the valve piston longitudinally (i.e., lengthwise) through a valve body or valve insert. Further, the valve may withstand high fluid flow pressures, such as pressures impinging inwardly into a valve bore, while keeping the valve piston in approximately the same position. Indeed, the valve may be suitable for use in a variety of operating conditions and environments that may include high fluid flow pressures, including applications in oil, gas, and/or water service. For example, the valve may be used in subsea oil and gas environments, where a high pressure fluid flow may include erosive fluid mixtures having sea water, sand, hydrocarbon liquids, and/or hydrocarbon gases. The valve may also be used topside (i.e., on the surface), for example, as part of a surface oil field operation.

In certain embodiments, the mechanical locking mechanism may include a clutch assembly, such as a slip clutch assembly, useful in locking or unlocking a shaft. In these embodiments, the lockable shaft may be coupled to the rotary-to-linear converter that may enable the conversion of the rotary motion into linear motion. The linear motion may be used to longitudinally position the valve piston in a number of positions between (and including) a fully closed position and a fully open position. By using the mechanical locking mechanism, the use of a hydraulic locking mechanism may be eliminated, resulting in a secure valve lock suitable for withstanding high operating pressures. Indeed, pressure of approximately 40,000 pounds per square inch (PSI) or higher may be used with the present embodiments.

The disclosed embodiments, including the clutch assembly, may also be used in valve embodiments having retrievable flow control inserts. In these embodiments, the retrievable flow control inserts enable in situ reconfiguration of the valve by facilitating the replacement of certain valve components, such as a choke trim, so as to accommodate a wide variety of operating conditions. For example, a remote operating vehicle (ROV) or a human diver may replace a subsea choke valve's flow control insert, thus reconfiguring the choke valve to more efficiently restrict or choke a production flow of hydrocarbons (e.g., oil and gas) from a subsea well. Indeed, valves having both retrievable as well as non-retrievable flow control inserts may be used. Further, the valve may incorporate a hydraulic control system having two modes of operation. In a “stepping” mode of operation, the hydraulic control system may gradually step or move the valve piston, so as to guide the valve piston into a desired position. In a “fast actuation” mode of operation, the hydraulic control system may move the valve piston into a closed position very quickly, in some cases, enabling the movement of the valve piston from a fully open to a fully closed position in less than approximately 10, 20, 30, or 40 seconds. Additionally, a shaft override mechanism may be provided, suitable for interfacing with the ROV or human diver and used to mechanically open or close the valve. Indeed, the shaft override mechanism may be used to manually open and close the valve, thus providing for a third valve actuation mechanism that may be used independently from the hydraulic control system and the rotary-to-linear converter.

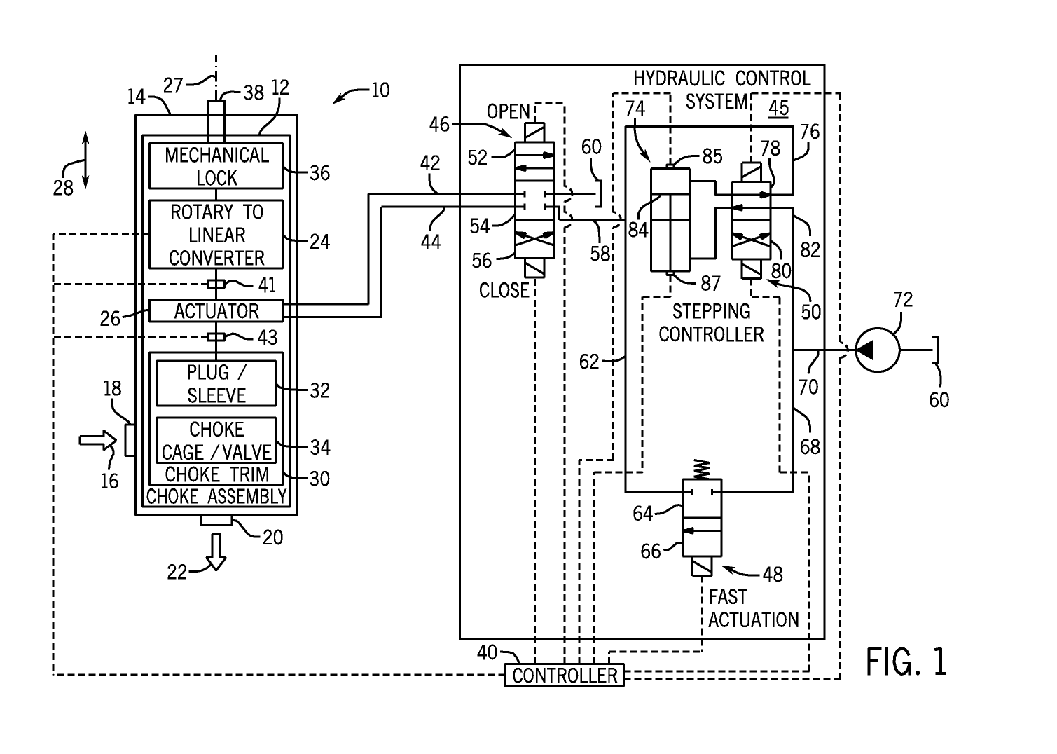

Turning now to the figures, FIG. 1 is block diagram of an embodiment of a valve 10 having a choke assembly 12 disposed inside of a valve body 14. The valve 10 may be suitable for controlling a flow 16 of a fluid, such as a liquid and/or a gas, and may be disposed in a variety of environments, including subsea and above-ground environments. In the depicted embodiment, the fluid flow 16 may enter the valve body 14 through a port 18 and into the choke assembly 12. The fluid flow 16 may include high pressure flows, such as those found in an oil or gas well. Indeed, in certain applications, the fluid flow 16 may include pressures of at least approximately 5,000 PSI, 20,000 PSI, 40,000 PSI. The choke assembly 12 is suitable for starting, stopping, or otherwise controlling the fluid flow 16 through the valve 10. Indeed, the choke assembly 12 may include various features for controlling the fluid flow 16 pressure across the valve 10, as described in more detail below. The fluid flow 16 may then exit the valve 10 through a port 20 as a fluid flow 22.

The choke assembly 12 may include features such as a rotary-to-linear converter 24 coupled to an actuator 26. The rotary-to-linear converter 24 may translate or convert a rotary torque into a linear motion suitable for moving the actuator 26 along a longitudinal axis 27 (e.g., axial axis 28). The actuator 26, such as a double-ended cylinder (i.e., a cylinder having a piston rod that protrudes out of both ends of the cylinder), may have one end coupled to the rotary-to-linear converter 24 and a second end may be further coupled to a choke trim 30. Specifically, the actuator 26 couples to a plug 32 of the choke trim 30 that may be used to partially and/or completely occlude one or more flow paths extending through a choke cage 34, which is also included in the choke trim 30. It should be noted that while the mechanism for occluding the choke cage 34 is presently described in context of the plug 32, other features such as a moveable sleeve may be utilized for the same purpose. In embodiments with a moveable sleeve, the sleeve may cover all or a portion of the choke cage 34 to restrict fluid flow. Alternatively or additionally, in some embodiments, the choke assembly 12 may include a needle and seat choke trim, a fixed bean choke trim, a plug and cage choke trim, an external sleeve choke trim, and/or a multistage choke trim. Moreover, while the choke assembly 12 is presently described as including a choke trim 30, in other embodiments the choke assembly 12 may not have a choke trim 30.

To allow the entry of the fluid flow 16, the choke cage 34 may generally include a substantially hollow cylindrical structure having one or more ports (e.g., a perforated annular wall). The one or more ports of the choke cage 34 may be designed to reduce fluid pressure of the incoming fluid flow 16 by requiring the fluid to follow a circuitous path before exiting the valve 10. In this way, the choke trim 30 may be a single or a multi-stage trim. Further, as will be appreciated, the ports of the choke cage 34 may be chosen for a particular application depending on the desired fluid dynamics and the specification of the well or other fluid source.

The valve 10 may further include a mechanical lock 36 coupled to a shaft override mechanism 38. In certain embodiments, the mechanical lock 36 may include a torque limiter suitable for locking the valve at a desired valve position (e.g., open position or closed position) and for protecting the valve 10 from overload. More specifically, the torque limiter may limit a torque (i.e., rotational force) by slipping or otherwise disengaging when the torque reaches or exceeds a certain force limit. The torque limiter may include, for example, a slip clutch or a friction clutch. Further, the mechanical lock 36 may use mechanical locking techniques, such as the aforementioned torque limiter, rather than hydraulic locking techniques. The use of the mechanical lock 36 enables a more secure locking of the valve 10 that prevents or eliminates valve leaks, including hydraulic leaks. The shaft override mechanism 38 may be used to override a valve controller 40. That is, the shaft override mechanism 38 may be used as another valve actuation device suitable for opening or closing the valve 10. Indeed, the shaft override mechanism 38 and the valve controller 40 may open and close the valve 10 independent of each other. Accordingly, an ROV or a human diver may manually engage the shaft override mechanism 38 and use the shaft override mechanism 38 to open or to close the valve 10.

FIG. 1 further illustrates the valve controller 40 suitable for use in controlling the valve 10. In the depicted embodiment, the valve controller 40 may use the rotary-to-linear converter 24 and/or a hydraulic control system 45 to open and to close the valve 10. By advantageously combining the rotary-to-linear converter 24 and the hydraulic control system 45, two separate driving mechanisms may be used in driving the actuator 26, thus enhancing controllability, flexibility, and safety. For example, the rotary-to-linear converter 24 may use electric power (e.g., electrically-driven motor) to drive the actuator 26, while the hydraulic control system 45 may use hydraulic power to drive the actuator 26, thus enabling the use of two different driving modalities. In the depicted embodiment, the valve controller 40 may sense the position of the actuator 26 by using one or more linear displacement sensors, such as linear variable differential transformer (LVDT) sensors 41 and 43, regardless of whether the rotary-to-linear converter 24 or the hydraulic control system 45 is moving the actuator 26. The LVDT sensors 41 and 43 may provide positional information of the location of the actuator 26 with respect to the choke assembly 12, thus enabling very precise positioning of the plug 32 with respect to the cage 34. Other types of linear displacement sensors also may be used, such as linear potentiometers, linear variable inductive transducers (LVITs), and the like. Furthermore, more (or less) LVDT sensors may be disposed at various locations in the valve 10.

As illustrated, the hydraulic control system 45 is fluidly coupled to the valve 10 through conduits 42 and 44. More specifically, the conduits 42 and 44 may be directly or indirectly coupled to the actuator 26 to enable the hydraulic control of the actuator 26 (e.g., double-ended cylinder actuator 26). Accordingly, the actuator 26 may be driven by the rotary-to-linear converter 24 and/or the hydraulic control system 45. By using at least two different driving modalities for the actuator 26, unexpected electrical issues may be overcome by using the hydraulic power, while unexpected hydraulic issues may be overcome by using the electric power.

The hydraulic control system 45 may include a “stepping” mode of operation and a “fast actuation” mode of operation. In the “stepping” mode of operation, the hydraulic control system 45 may gradually “step” or move the actuator 26 along the longitudinal axis 27 (e.g., axial axis 28). The stepping movement of the actuator 26 may be an approximately replicable discrete movement. That is, each actuation step may result in approximately the same movement distance. By enabling a “stepping” mode of operation, the hydraulic control system 45 may allow for very precise control over the incoming flow 16. Indeed, in certain embodiments, the control system 45 may more precisely position the actuator 26 (and the plug 32) by moving the actuator 26, for example, approximately 0.1, 0.5, 1, 2, 3, 4, 5, 6, 7, 8, 9, or 10 percent of a distance between fully open and fully closed, on each actuation step.

In the “fast actuation” mode of operation, the hydraulic control system 45 may enable a rapid movement of the actuator 26 from a fully open position to a fully closed position of the actuator 26, for example, by continuously driving the actuator 26 until the actuator 26 reaches the fully closed position. Such a “fast actuation” mode may completely close the valve 10 in less than approximately 10, 15, 20, or 30 seconds. By providing the “stepping” and the “fast actuation” modes of control, the hydraulic control system 45 may enhance the control flexibility of the valve 10 and improve the operational safety of systems connected to the valve 10. For example, the valve 10 may be closed quickly in response to unexpected events downstream of the valve 10.

In order to provide both a “stepping” mode and a “fast actuation” mode of control, the hydraulic control system 45 may include three solenoid valves 46, 48, and 50. In one embodiment, the solenoid valve 46 may be a three-position, flow control solenoid valve 46 having an open position 52 (i.e., forward flow position), a stop position 54 (i.e., stop flow position), and close position 56 (i.e., reverse flow position). When the valve 46 is in the stop position 54, approximately no hydraulic fluid (e.g., oil or water) will flow through the valve 46. When the valve 46 is in the open position 52, then a fluid may be directed through a conduit 58 to flow through to the conduit 44, thus providing hydraulic power suitable for driving the actuator 26 into an open position (e.g., moving the plug 32 outwardly away from the choke cage 34). The fluid may then return through the conduit 42 and be directed into a reservoir 60.

When the valve 46 is in the close position 56, the direction of fluid flow is reversed. Accordingly, fluid directed through the conduit 58 may now flow through the conduit 42, reversing the actuator 26 towards a close position (e.g., moving the plug 32 inwardly towards the choke cage 34). The return fluid flow may now enter the conduit 44 and be directed into the reservoir 60. Accordingly, the solenoid valve 46 is capable of opening or closing the valve 10 with fluid directed through the conduit 58.

During the “fast actuation” mode of control, fluid may be continuously directed to the conduit 58 (and the solenoid valve 46) by the solenoid valve 48 until the actuator 26 completely closes the valve 10. More specifically, fluid may be directed to the conduit 58 by using a conduit 62. In one embodiment, the solenoid valve 48 is a two-position, flow control solenoid valve 48 having a stop position 64 (i.e., stop flow position) and an open position 66 (i.e., forward flow position). In the stop position 64, approximately no fluid will flow through the valve 48. In the open position 66, the valve 48 may direct fluid to the conduit 58 (and the solenoid valve 46) through the conduit 62, thus enabling the “fast actuation” mode. In the illustrated embodiment, the fluid may be directed into the valve 48 through a conduit 68 and a conduit 70. A pump 72, such as a hydraulic pump suitable for pumping the fluid from the reservoir 60, may be used to provide hydraulic pressure.

During the “stepping” mode of control, the valve 50 may be combined with a cylinder 74 so as to provide a discrete or fixed quantity of the fluid flow into the conduit 58 (and the solenoid valve 46) through a conduit 76. In the depicted embodiment, the valve 50 is a two-position, flow control solenoid valve 50 having an open position 78 (i.e., forward flow position) and a close position 80 (i.e., reverse flow position). Further, the valve 50 may receive fluid through a conduit 82 directed by the pump 72. The cylinder 74 may include a piston or ram 84 suitable for driving fluid through the cylinder 74. In certain embodiments, the cylinder 74 and the piston 84 may be sized to achieve a specific displacement ratio R between a full displacement (i.e., movement from one end of the cylinder 74 to an opposite end of the cylinder 74) of the piston 84 and a displacement of the actuator 26. That, is, a first movement of the piston or ram 84 from one end of the cylinder 74 to the opposite end of the cylinder 74 may cause a second movement of the actuator 26, where the second movement of the actuator 26 may be calculated by using the displacement ratio R (e.g., 1 to 100, 1 to 500, 1 to 1,000, 1 to 10,000). For example, if the displacement ratio R is approximately 1 to 100, every full displacement of the piston or ram 84 (i.e., movement of the piston or ram 84 from one end of the cylinder 74 to the opposite end of the cylinder 74) may cause approximately 1/100 or a 1% displacement of the actuator 26. If the actuator 26 has, for example, a displacement of approximately 100 cm, then the 1 to 100 ratio may move the actuator 26 approximately 1 cm. In this example of the actuator 26 having a displacement of approximately 100 cm, a 1 to 500 ratio may move the actuator 26 approximately 0.2 cm. Likewise, in this example of the actuator 26 having a displacement of approximately 100 cm, a 1 to 10,00 ratio may move the actuator 26 approximately 0.1 cm. It is to be noted that the cylinder 74 and the piston or ram 84 may be sized according to a variety of values for the displacement ratio R. For example, Pascal's law or the principle of transmission of fluid-pressure may be used to size the cylinder 74 (and the piston or ram 80) when used in conjunction with the actuator 26, so as to approximate a desired value for the displacement ratio R. Further, the cylinder 74 and/or the piston 84 may be adjusted or replaced so as to adjust the ratio R. For example, the starting and ending positions of the piston 84 may be modified in order to deliver a different discrete quantity of the fluid. It is also to be understood that in other embodiments, the piston 84 may be replaced with a diaphragm or combined with a diaphragm.

In the depicted embodiment, the cylinder 74 includes a pulsed feature that enables a pulsed or rhythmic delivery of the discrete fluid quantities. The discrete fluid pulses may be achieved, for example, by using proximity switches 85 and 87. The proximity switches 85 and 87 may include limit switches, Hall effect switches, photodiodes, acoustic proximity switches, and so forth, suitable for detecting the position of the piston 84. When the piston 84 has reached either ends of the cylinder 74 (i.e., full extension or full retraction), then the proximity switch 85 or 87 may activate the two-position valve 50. For example, when the piston 84 has reached approximately full extension, then the position switch 85 may active the valve 50 to the reverse flow position 80, causing the valve 50 to retract the piston 84. Once the piston 84 has reached approximately full retraction, then the position switch 87 may activate the valve 50 to the forward flow position 78, causing the valve 50 to extend the piston 84 to direct the discrete quantity of fluid into the valve 46, which may then direct the fluid so as to drive the actuator 26. This automatic shuttling of the piston 84 from one end of the cylinder 74 to the opposite end of the cylinder 74 may result in the pulsing of the discrete quantities of the fluid. For example, opening the valve 46 during pulsatile operations of the valve 50 may result in the transmission of the discrete quantities of the fluid so as to drive the actuator 26.

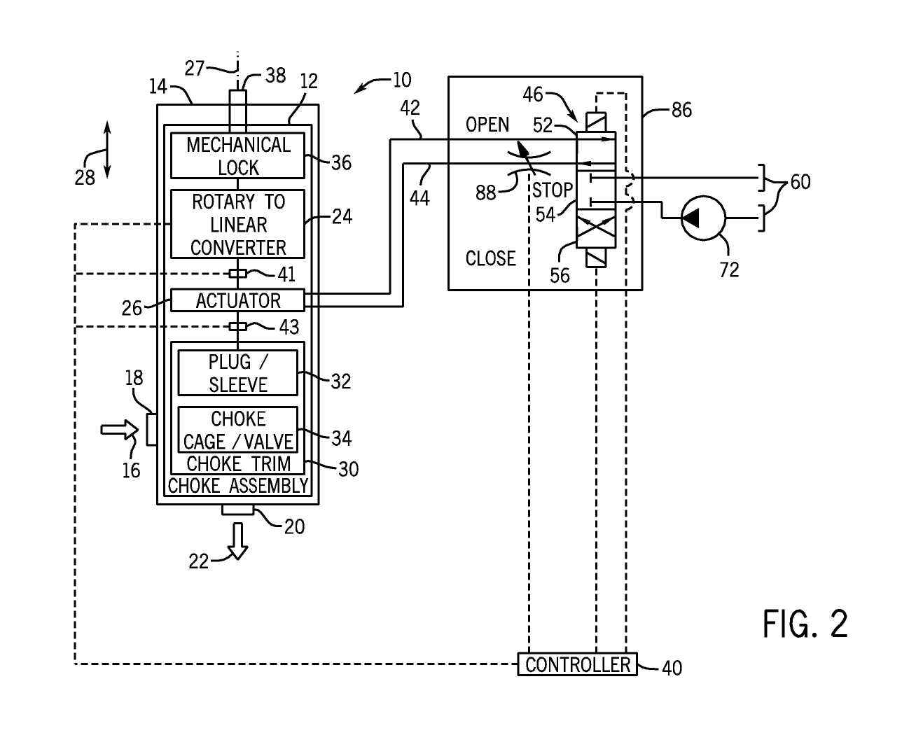

It is to be noted that the hydraulic control system 45 may be used to control a variety of valves, such as choke valves, gate valves, ball valves, plug valves, and the like. Additionally, the hydraulic control system 45 could be used in applications that may benefit from discrete fluid flows and/or fast actuation, such as applications using positive displacement pumps. It is also to be noted that the valve 10 may use other hydraulic control embodiments, such as a hydraulic control system described in more detail with respect to FIG. 2.

FIG. 2 illustrates the valve 10 of FIG. 1 incorporating a hydraulic control system 86. In the illustrated embodiment, certain components described in detail above with reference to FIG. 1 are indicated with like element numbers. Similar to FIG. 1, the embodiment of FIG. 2 may also benefit from combining the use of the rotary-to-linear converter 24 with hydraulic control, such as the hydraulic control system 86. Indeed, combining the electrically powered rotary-to-linear converter 24 with the hydraulically powered control system 86 may improve valve 10 flexibility, controllability, and safety.

In the depicted embodiment, the hydraulic control system 86 includes the three-position, fluid control solenoid valve 46 and an adjustable restrictor valve 88. As mentioned above, the controller 40 may control the solenoid valve 46 by cycling between the three valve positions 52, 54, and 56 so as to direct fluid from the pump 72 into the conduits 42 and 44. Indeed, the conduits 42 and 46 may be used as the fluid conduits suitable for opening and closing the actuator 26. The restrictor valve 88 may be adjusted so as to restrict the fluid flow through the conduit 44. By restricting the fluid flow, a desired displacement rate for the actuator 26 may be achieved. More specifically, the flow of fluid may be controlled such as a desired fluid volume flows into the actuator 26 in a given unit of time. Accordingly, the restrictor valve 88 may be adjusted to control the movement of the actuator 26 a desired distance for a given amount of time. For example, the restrictor valve 88 may be adjusted to provide approximately 1, 2, 3, 4, 5, 6, 7, 8, 9 or 10 cm/sec movement of the actuator 26. In this way, the controller 40 may suitably control the opening and the closing of the valve 10 using the single three-way valve 46 and the single restrictor valve 88. By using only two valves 46 and 88, the hydraulic control system 86 may include a reduced number of components, thus decreasing maintenance time and cost.

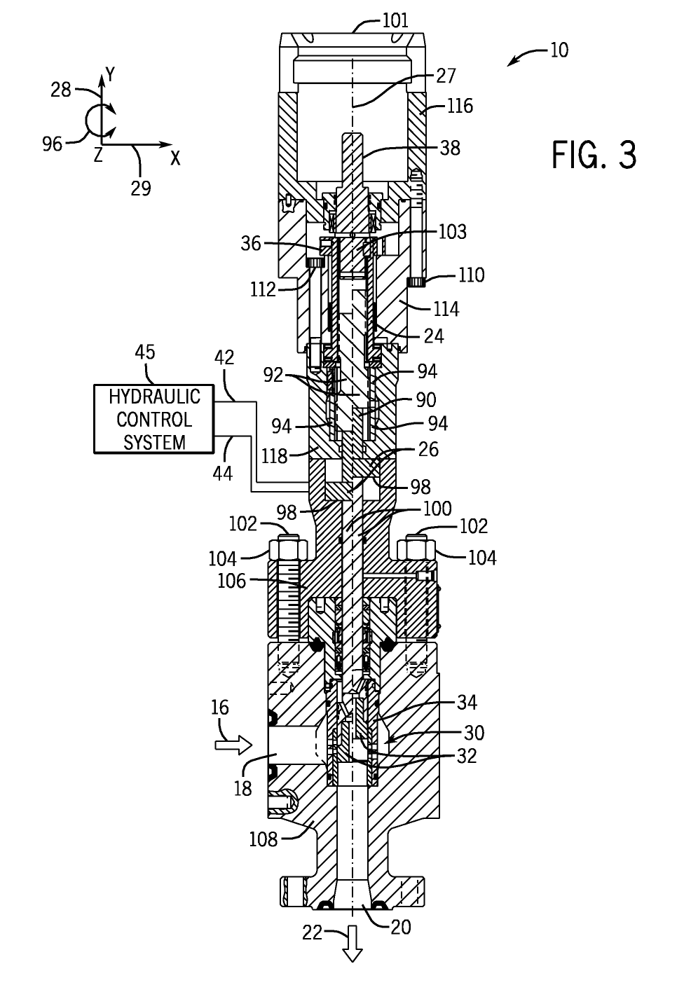

FIG. 3 illustrates a cross-sectional view of the valve 10 of FIGS. 1 and 2. It is to be noted that the figure depicts two positions. A first position depicted on the left-half if the figure illustrates the actuator 26 in fully closed position, and a second position depicted on the right-half of the figure illustrates the actuator 26 in a fully opened position. As mentioned above, the valve 10 may advantageously combine an electrically driven rotary-to-linear converter 24 with a hydraulic control system 45 to drive the actuator 26. By combining the two drive mechanisms 24 and 45, the actuator 26 may be energized by using electric power and/or hydraulic power, providing enhanced control flexibility and increased safety. In the depicted embodiment, the actuator 26 is a double-ended cylinder 26. A first end 90 of the actuator 26 may be coupled to a threaded shaft 92 of the rotary-to-linear converter 24. In the depicted embodiment, the rotary-to-linear converter 24 is a roller screw 24 (e.g., planetary roller screw) suitable for converting rotary motion into linear motion. Further, the roller screw 24 may be able to apply high thrust loads with minimum internal friction. More specifically, the roller screw 24 may include multiple screws 94 positioned circumferentially around the shaft 92 and mated to the threads of the shaft 92. The screws 94 may be rotated 360° around the circumference of the shaft 90 (i.e., rotation about the y-axis 28). Such a rotation 96 may translate into a longitudinal movement of the threaded shaft 92 along the y-axis 28 suitable for providing a high trust capable of obstructing or occluding the incoming flow 16. In one example, a clockwise rotation 96 may result in the shaft 92 moving towards the port 18, while a counterclockwise rotation 96 may result in the shaft 92 reversing directions and moving away from the port 18. In another example, the counterclockwise rotation 96 may result in the shaft 92 moving towards the port 18, while the clockwise rotation 96 may result in the shaft 92 reversing directions and moving away from the port 18. In other embodiments, the rotary-to-linear converter 24 may use a ball screw or a lead screw (i.e., translation screw or power screw) to translate rotational motion into linear motion. The ball screw, for example, may provide a spiral raceway for ball bearings that may act as a precision screw. The lead screw or power screw may provide a threaded shaft disposed inside a grooved body suitable for providing linear motion upon rotation of the grooved body.

In the depicted embodiment, an end 98 of the actuator 26 may be coupled to a stem 100. In turn, the stem 100 may be coupled to the plug 32 of the choke trim 30. Accordingly, the longitudinal movement of the actuator 26 may result in an equivalent longitudinal movement of the plug 32. In this way, the plug 32 may be used to partially or fully occlude the choke cage 34. By occluding the choke cage 34, the incoming fluid flow 16 may be controlled, thus controlling the outgoing fluid flow 22 exiting the valve 10. It is to be noted that the flows 16 and 22 may be reversed. That is, the flow 22 may be an incoming flow while the flow 16 may be an outgoing flow. Indeed, the valve 10 may direct fluid incoming through the port 18 and outgoing through the port 20, or vice versa.

As mentioned above, the hydraulic control system 45 may direct fluid through conduits 42 and 44 suitable for hydraulically actuating the actuator 26. Accordingly, the actuator 26 may be driven by using the hydraulic control system 45 in addition to or as an alternative to the rotary-to-linear converter 24. Indeed, the rotary-to-linear converter 24 may be back-driven by using the hydraulic control system fluidly coupled to the actuator 26. That is, hydraulic pressure may be used to move the actuator 26 along the y-axis 28, and this linear movement may be allowed to occur though the rotary-to-linear converter 24 without undue friction. That is, the rotary-to-linear converter 24 may convert linear motion to rotary motion, thus enabling the actuator 26 to be moved by the hydraulic control system 45 without having to apply electric power to the rotary-to-linear converter 24. Likewise, the rotary-to-linear converter 24 may back-drive the hydraulic control system 45. That is, electric power may be used to move the actuator 26 without the need to apply hydraulic power. It is to be understood that the hydraulic control system 45 may incorporate, for example, a bypass valve to more efficiently enable the back-driving of the actuator 26 when using only the rotary-to-linear converter 24 as the driving mechanism.

The actuator 26 may also be manually driven, for example, by a human diver or an ROV. In this mode of actuation, the human diver or ROV may use the shaft override mechanism 38 to open or close the valve 10. For example, the diver or ROV may use a bucket or guide 101 to lower a tool suitable for engaging the shaft override mechanism 38. The shaft override mechanism 38 may be coupled to the rotary-to-linear converter 24 through a shaft 103, and rotating the shaft override mechanism 38 may result in an equivalent rotation of the rotary-to-linear converter 24. As mentioned above, the rotations may be translated into linear motion, thus opening or closing the valve 10. Indeed, multiple mechanisms for opening and closing the valve 10 are described herein, including hydraulic power, electric power, and manual power. Further, the valve 10 may incorporate features, such as the mechanical lock 36, suitable for locking or preventing unwanted opening or closing of the valve 10.

In one embodiment, the mechanical lock 36 may be a torque limiter, such as a slip clutch (e.g., ball detent) or a friction clutch. The ball detent, for example, may include multiple spring-biased balls placed inside pockets of the slip clutch, as described in more detail with respect to FIGS. 7 and 8. It is to be noted that other torque limiter types are contemplated, including magnetic torque limiters, pawl and spring torque limiters, friction plate torque limiters, and the like. The mechanical lock 36 may prevent unwanted rotary motion while also protecting the valve 10 components from overload. For example, the mechanical lock 36 may securely engage the shaft 103 coupled to the rotary-to-linear converter 24, thus aiding in securing the valve 10 at a desired flow position. However, should the rotary torque reach an undesired torque level, then the torque limiter may “slip” or otherwise disengage, thus safeguarding the equipment from reaching undesired torque levels.

In the depicted embodiment, the valve 10 may include features, such as threaded screws or bolts 102 and nuts 104, that may enable a quick disassembly and replacement of certain valve 10 components. For example, the nuts 102 and the screws 104 may secure a bonnet assembly 106 to a lower valve housing 108. Removing the bolts 102 may allow access to the choke trim 30. Accordingly, the choke trim 30 and associated components, such as the plug 32 and the cage 34, may be accessed for maintenance, repair, or replacement. Likewise, screws or bolts 110 and 112 may be used to gain access to the rotary-to-linear converter 24. For example, the bolt 110 may be used to connect and disconnect an upper mounting assembly 114 from a bucket housing 116, while the bolt 112 may be used to connect and disconnect the upper mounting assembly 114 from a middle assembly 118, thus gaining access to the rotary-to-linear converter 24 for maintenance, repair, or replacement.

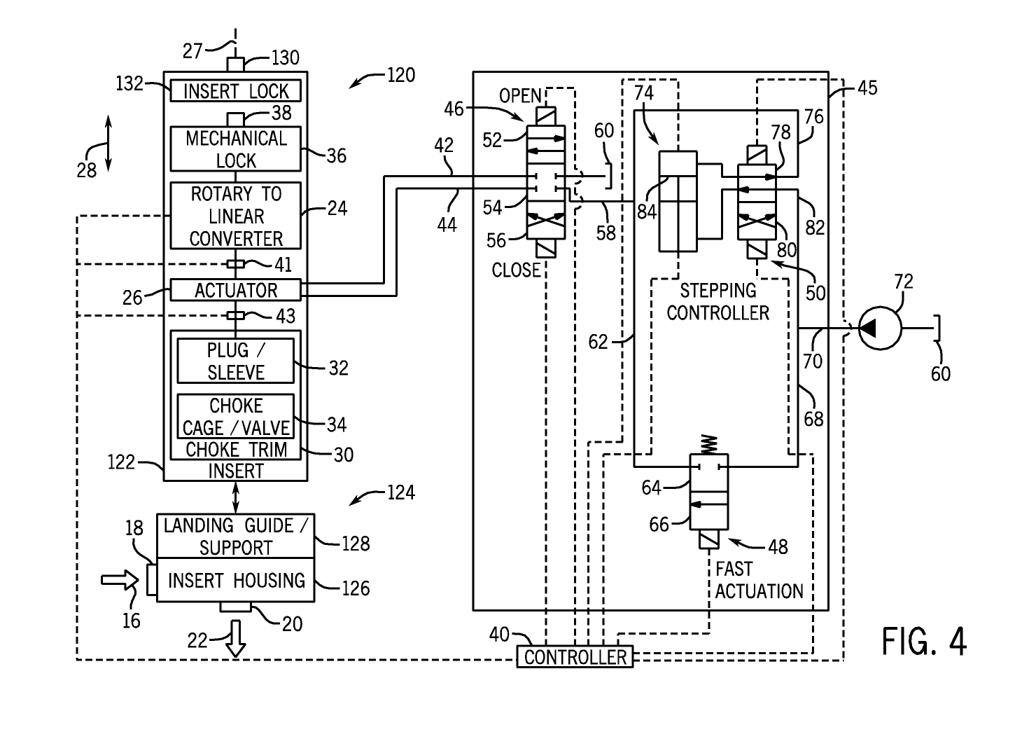

In some embodiments, such as the embodiments described in more detail below with respect to FIG. 4, certain features, such as a flow control insert, may be used to enable a more flexible maintenance, repair, and replacement of the valve components described herein. FIG. 4 depicts an embodiment of a valve 120 having a flow control insert 122. In the illustrated embodiments, certain components described in detail above with reference to FIGS. 1 and 2 are indicated with like element numbers. The flow control insert 122 enables the extraction and replacement of certain valve 120 components, such as the rotary-to-linear converter 24, the actuator 26, the choke trim 30 (e.g., plug 32 and choke cage 34), and the mechanical lock 36 coupled to the rotary-to-linear converter 24 through the shaft 103. Advantageously, the choke cage 34, and in some embodiments the choke trim 30, may be swappable (i.e., removable and replaceable) with respect to the flow control insert 122, for example by coupling onto a body or other feature of the insert 122 to allow a single flow control insert 122 to be used in a variety of applications, including subsea applications. The rotary-to-linear converter 24, the actuator 26, and the mechanical lock 36 may also be swappable with respect to the flow control insert 122.

The valve 120 includes a non-retrievable portion 124 having a flow control insert housing 126 (e.g., a choke body) coupled to a landing guide/support 128. Although the non-retrievable portion 124 is presently described as being substantially permanent, such language is intended to distinguish it from a portion that may be retrieved on a more frequent basis, and is not intended to limit the scope of the present disclosure. That is, the flow control insert housing 126 and the landing guide/support 128 are permanent with respect to the retrievable flow control insert 122 of the valve 120. However, in other embodiments, such as during or after well closure, the flow control insert housing 126 may be retrieved if desired.

In a general sense, FIG. 4 illustrates the flow control insert 122 during the process of being deployed, wherein the flow control insert 122 is deployed subsea using one or more suitably configured features of an offshore drilling system, such as a running tool 130. A portion of the running tool 130 is illustrated as attached to the flow control insert 122. The flow control insert 122 generally includes an insert locking system 132 configured to lock the flow control insert 122 into the insert housing 126 once the flow control insert 122 has been disposed into the insert housing 126. As described above, the rotary-to-linear converter 24 may be used to provide a first mechanism (e.g., electrical mechanism) suitable for opening or closing the valve 120, while the hydraulic control system 45 may provide a second mechanism (e.g., hydraulic mechanism) also suitable for opening and closing the valve. Indeed, as described above, both the rotary-to-linear converter 24 as well as the hydraulic control system 45 may drive the actuator 26 so as to move the plug 32 at different longitudinal positions relative to the choke cage 34. In this way, the fluid flow 16 entering the port 18 may be controlled. That is, the fluid flow 16 may enter the port 18, traverse the insert housing 126, and exit through the port 20 as the fluid flow 22. By providing the flow control insert 122 and the insert housing 126, it may be possible to reconfigure the valve 120 during subsea operations to more suitably operate in certain environments.

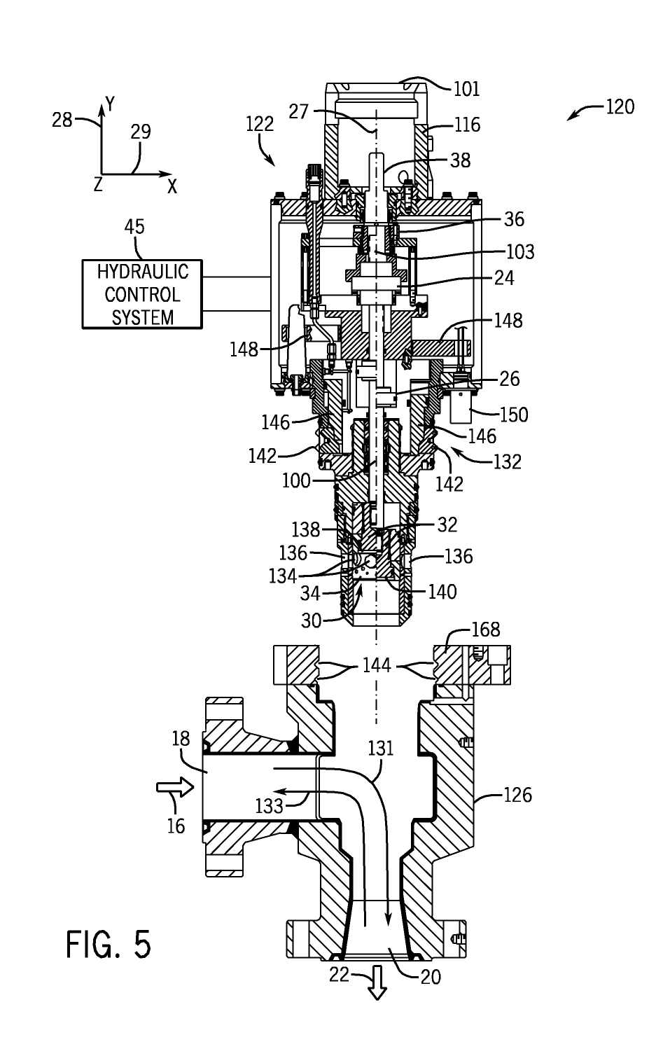

FIG. 5 is an exploded cross-sectional plan view of the arrangement of FIG. 4, where the flow control insert 122 is approaching the insert housing 126 (or being retrieved from the insert housing 126). It is to be noted that the figure depicts two positions. A first position depicted in the left-half of the figure illustrates the actuator 26 in a fully opened position, and a second position depicted in the right-half of the figure illustrates the actuator 26 in a fully closed position. The cross-sectional view of FIG. 5 illustrates various features of the rotary-to-linear converter 24, the actuator 26, the choke trim 30 (e.g., plug 32, choke cage 34), and the insert lock mechanism 132. Additionally, the cross-sectional view of the insert housing 126 illustrates a first fluid path 131 through which extracted fluids may flow through the valve 120 when assembled. That is the fluid flow 16 may enter the port 18, traverse the insert housing 126, and exit the port 20 as the fluid flow 22. However, in other embodiments, fluids may flow through the valve 120 via a second fluid path 133.

The actuator 26, as noted above, generally controls the longitudinal displacement of the plug 32 to control the amount of fluid passing through the choke cage 34. Specifically, the plug 32 moves along the longitudinal axis 28 to occlude one or more interior ports 134 of the choke cage 34. The interior ports 134 of the choke cage 34 generally coincide with one or more exterior ports 136 of the choke cage 34. The interior ports 134 and the exterior ports 136 may be aligned and/or misaligned so as to cause fluid flowing through from the interior of the choke cage 34 to the exterior of the choke cage 34 to have a reduced flow rate and, therefore, a reduced pressure. In such an embodiment, the choke trim 30 may be considered a multi-stage choke trim, wherein pressure is reduced in more than one stage so as to prevent fluid cavitation from steep pressure drops. It should be noted, however, that the use of single-stage choke trims are also presently contemplated and may be used in accordance with the present disclosure.

To move the plug 32 along the longitudinal axis 28, the rotary-to-linear converter 24 and/or the hydraulic control system 45 may cause the movement of the shaft 100 attached to the plug 32. The plug 32 may be moved in a stepwise fashion between a fully open position 138 and a fully closed position 140. In the fully closed position 140, the plug 32 may completely occlude the choke cage 34, thus preventing any fluid from flowing through the insert housing 126. In the fully open position 138, the plug 32 may leave the choke cage 34 completely open to the flow of fluid through the insert housing 126. In the illustrated embodiment, the plug 32 may move a percentage between each position 138 and 140. For example, in a single step, the plug may move between about 5 percent and about 50 percent of the distance between the two positions 138 and 140. Indeed, in some embodiments, the plug 32 may move at least approximately 5, 10, 15, 20, 25, 30, 35, 40, 45 or 50 percent, or more of the distance between the two positions 138 and 140.

As noted above, various features of the insert locking mechanism 132 may also be appreciated with respect to FIG. 5. It should be noted that while a dog-in-window configuration is presently described to facilitate explanation, other locking mechanisms 132 are also contemplated herein, such as clamps, collets, threads, snap fits, interference fits, one or more bonnet bolts, a bayonet, and so on. In the illustrated embodiment, the insert locking mechanism 132 includes the moveable members 142 that are capable of being cammed radially outward (with respect to the longitudinal axis 28) to lock into the recesses 144 of the insert housing 126. For example, sliding sleeves 146 may cause the camming action of the moveable members 142. The sliding sleeves 146 may be mechanically actuated, for example, by using a force plate 148. The force plate 148 may be actuated by using push-pull rods or another suitable mechanism. As the sleeves 110 slide against the moveable members 142, the moveable members 142 may be biased outwardly in a radial direction 29, so as to engage the grooves 144 of the insert housing 126. In this way, the insert 122 may be secured to the insert housing 126. Additionally, the insert 122 may include the bucket or guide 101 attached to the bucket housing 116 and suitable for aiding in the positioning of the insert 122 into the insert housing 126.

In one embodiment, once the valve 120 is assembled by positioning the insert 122 into the insert housing 126, an electrical connector 150 may be used to provide electrical power and transfer electrical signals to/from the valve 120. Likewise, the hydraulic control system 45 may be used to provide hydraulic power. Indeed, by advantageously combining electrical power with hydraulic power, increased control flexibility, reliability, and safety may be achieved.

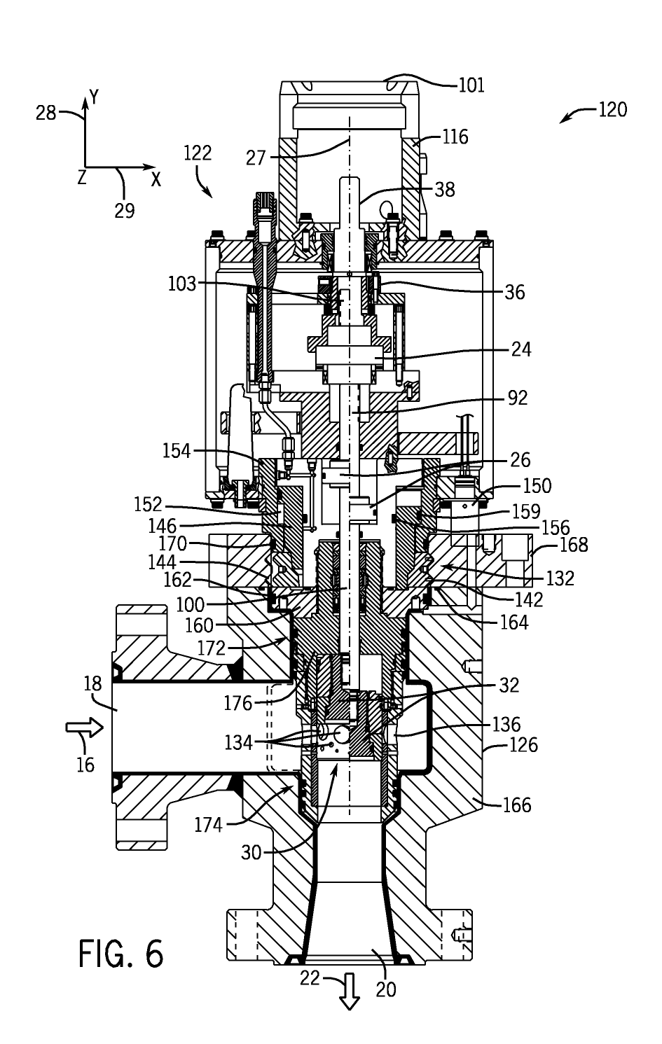

FIG. 6 depicts a cross-sectional view of an embodiment of the assembled valve 120 of FIG. 5. That is, the depicted embodiment illustrates the insert 122 placed into the insert housing 126. It is to be noted that the figure depicts two positions. A first position depicted on the left-half if the figure illustrates the actuator 26 in fully closed position, and a second position depicted on the right-half of the figure illustrates the actuator 26 in a fully opened position. In some situations, it may be desirable to operate the insert locking mechanism 132 using one or more secondary features. Accordingly, the insert locking mechanism 132 may include one or more features such as hydraulic lines, hydraulic sources, and so on for driving the insert locking mechanism 132. Specifically, hydraulic fluid (e.g., water or oil) may be injected into a cavity 152 defined between the sliding sleeve 146 and a housing 154 partially enclosing various portions of the locking mechanism 132. Additionally, an inner seal 156 (e.g., annular seal) and an outer seal 158 (e.g., annular seal) are disposed on opposing sides of the sleeve 146 to block the ingress of seawater into the moving joints of the locking mechanism 132, specifically the joint between the sleeve 146 and the moveable members 142.

The moveable members 142 are supported by a lower support plate 160, which rests against the insert housing 126. The lower support plate 160 is sealed against the housing 126 using a seal 162. Seal 162 (e.g., annular seal), in conjunction with a seal 164 (e.g., annular seal) disposed between a body 166 of the housing 126 and a top flange 168 of the housing 126, blocks the ingress of seawater or other contaminants into the insert locking mechanism 132 at an area proximate the lower support plate 160 and the moveable members 142. Additionally, a seal 170 (e.g., annular seal) is disposed between the housing 154 and the top flange 168 to seal an end of the moveable members 142 opposite the lower support plate 160 from seawater and other contaminants.

In addition to the seals proximate the insert locking mechanism 132, the insert 122 includes other seals disposed proximate the choke trim 30 for blocking exposure to seawater and damage to various components. For example, the choke trim 30 is flanked by two pairs of annular seals, e.g., an upper pair of seals 172 and a lower pair of seals 174 (e.g., a nose seal). The upper seals 172 may isolate an internal pressure within the choke trim 30 from the environment surrounding the insert 122 (e.g., seawater). The upper seals 172 may also aid in sealing a hub 176 of the insert 122 against the housing 126. The hub 176 is generally configured to allow attachment of the choke trim 30 to the insert 122 and to support the lower support plate 160. The lower seals 174 are disposed on the choke trim 30 below the choke trim 30, and are configured to isolate the upstream pressure of the insert 122 from the downstream pressure of the insert 122.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system comprising:
a hydraulic control system comprising:
a first valve configured to deliver a fluid through a first fluid path to actuate a device;
a first piston disposed in a cylinder and configured to deliver a discrete quantity of the fluid to the first valve through a second fluid path;
a second valve configured to provide the fluid to the first piston through a third fluid path; and
a third valve configured to provide a continuous quantity of the fluid through the second fluid path to the first valve.

2. The system of claim 1, wherein the device comprises at least one of a second piston, a diaphragm, a subsea valve system, or a topside valve system.

3. The system of claim 1, wherein the first valve comprises a three-position flow control valve.

4. The system of claim 3, wherein the three-position flow control first valve comprises a forward flow position, a stop flow position, and a reverse flow position.

4. The system of claim 1, wherein the second valve comprises a two-position flow control valve.

5. The system of claim 4, wherein the two-position flow control second valve comprises a forward flow position and a reverse flow position.

6. The system of claim 1, wherein the third valve comprises a two-position flow control valve.

7. The system of claim 6, wherein the two-position flow control third valve comprises a stop flow position and a forward flow position.

8. The system of claim 1, comprising a first and a second proximity switch, wherein the first and the second proximity switches are configured to alternate the direction of the first piston to deliver pulses of the discrete quantity.

9. The system of claim 1, wherein a displacement ratio R of a full displacement of the first piston to a stepwise displacement of the device, is used to determine the discrete quantity of the fluid.

10. The system of claim 9, wherein the position of the first piston with respect to the cylinder is adjustable to adjust the displacement ratio R.

11. The system of claim 1, wherein the device comprises a valve system having a rotary-to-linear converter and a fourth fluid path, wherein the rotary-to-linear converter, the fluid, or a combination thereof, are configured to open and close the fourth fluid path.

12. A system comprising:
a hydraulic control system comprising:
a discrete hydraulic supply system configured to supply a plurality of discrete quantities of a hydraulic fluid to drive a hydraulic system in a stepwise manner; and
a continuous hydraulic supply system configured to supply a continuous flow of the hydraulic fluid to drive the hydraulic system in a continuous manner, wherein the hydraulic control system is configured to operate the discrete hydraulic supply system and the continuous hydraulic supply system independently from one another.

13. The system of claim 12, wherein the discrete hydraulic supply system is configured to adjust a volume of the discrete quantities of the hydraulic fluid.

14. The system of claim 12, wherein the discrete hydraulic supply system is configured to provide a pulsed discrete quantity of the fluid flow.

15. The system of claim 14, wherein the discrete hydraulic supply system comprises a piston configured to travel between a first position and a second position to provide the pulsed discrete fluid flow.

16. The system of claim 15, wherein the discrete hydraulic supply system comprises a first proximity switch configured to detect when the piston is in the first position and a second proximity switch configured to detect when the piston is in the second position to provide the pulsed discrete fluid flow.

17. The system of claim 16, wherein the discrete hydraulic supply system comprises a third valve communicatively coupled to the first and to the second proximity switch and configured to move the piston from the first position to the second position to provide the pulsed discrete fluid flow.

18. A system comprising:
a controller configured to control a hydraulic system; wherein the controller is configured to control a plurality of discrete quantities of a hydraulic fluid provided to the hydraulic system and a continuous flow of the hydraulic fluid provided to the hydraulic system.

19. The system of claim 18, wherein the controller is configured to control a hydraulic control system configured provide the discrete quantities and the continuous flow of the hydraulic fluid.

20. The system of claim 18, wherein the controller is configured to use a fast actuation mode to control the continuous flow of the hydraulic fluid and a discrete actuation mode to control the discrete quantities of the hydraulic fluid.
